(19) United States
(12) Patent Application Publication
(10) Pub. No.: US 2015/0113768 A1
(43) Pub. Date: Apr. 30, 2015

(54) FOLDING DOOR APPARATUS FOR VEHICLE

(71) Applicant: Hyundai Motor Company, Seoul (KR)

(72) Inventor: Seung Jae Lee, Whasung-Si (KR)

(73) Assignee: Hyundai Motor Company, Seoul (KR)

(21) Appl. No.: 14/271,097

(22) Filed: May 6, 2014

(30) Foreign Application Priority Data
Oct. 29, 2013 (KR) 10-2013-0129296

(51) Int. Cl. E05F 5/08

(52) U.S. Cl. CPC E05F 5/08
USPC 16/86 R

(57) ABSTRACT

A folding door apparatus for a vehicle that includes a stopper guide disposed at a body side of a vehicle. The stopper guide is positioned at a point where a lower end of a door of the vehicle adjoins. One side of the stopper guide is opened to form an accommodation recess. A stopper has a protrusion corresponding to the accommodation recess of the stopper guide and shock-absorbing parts on both sides of the protrusion. The width of the shock-absorbing parts is variable in the transverse direction of the stopper.

### CROSS-REFERENCE(S) TO RELATED APPLICATION

The present application claims priority of Korean Patent Application Number 10-2013-0129296 filed on Oct. 29, 2013, the entire contents of which application is incorporated herein for all purposes by this reference.

### BACKGROUND OF INVENTION

1. Field of Invention

The present invention relates to a folding door of a bus, and more particularly, to a folding door apparatus for a vehicle in which a stopper is fastened with a stopper guide irrespective of the direction in which a door moves, and in which noise/background sound can be reduced.

2. Description of Related Art

In general, a large vehicle such as a minibus for carrying a number of passengers is equipped with a folding door which can be folded into half sections so that passengers can easily get on or off the vehicle through a limited door opening space. The folding door is intended to promote the convenience of passengers as well as the security of the vehicle. The folding door is coupled to a rail part which is disposed in the section behind the driver's seat in the longitudinal direction of the vehicle such that the folding door can be folded. The door is mounted with a roll which can move on the rail part, and is provided with a stopper corresponding to a guide stopper on a vehicle body.

Unlike a door of a car, when the folding door is closed, the stopper controls the longitudinal step of the door in the state in which the rear section of the folding door is fastened to a door latch and the front section of the folding door is not fastened. When the sliding door is closed, the door can move inward/outward as much as the gap between the rail part and the roll. At this time, a side surface of the guide stopper interferes with a side surface of the stopper, thereby damaging the surface of the stopper.

In order to overcome this problem, a TPO material based on synthetic resin is applied for the stopper and the guide stopper. However, when a vehicle turns or runs on a bumpy road, noise is created due to friction between the stopper and the guide stopper made of the TOP material, which is problematic.

Korean Utility Model Laid-Open Application No. 2000-0009689 has disclosed a stopper and stopper guide structure of a folding door in which pillars are provided at both sides and a folding door is provided between the pillars. A stopper guide is provided on one pillar side on the inner side of the folding door using a fixing device, a guide recess is formed in the central portion of the stopper guide, and a bent stopper is provided on a panel on the inner side of the folding door. The stopper is formed integrally with the folding door, moves along with the folding door, and can be inserted into the guide recess of the stopper guide. According to this structure, however, noise/background sound is not properly reduced. In addition, when the door is repositioned, the stopper and the guide stopper are not fastened with each other.

Therefore, there is required a folding door apparatus for a vehicle in which the stopper and the guide stopper are properly fastened with each other and noise/background sound is not created even if the position of the door is changed.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made keeping in mind the above problems occurring in the related art and/or other problems, and the present invention is intended to propose a folding door apparatus for a vehicle in which a stopper and a guide stopper are properly fastened with each other and noise/background sound is not created even if the position of the door is changed

Various aspects of the present invention provide for a folding door apparatus for a vehicle that includes a stopper guide disposed at a body side of a vehicle. The stopper guide is positioned at a point where a lower end of a door of the vehicle adjoins. One side of the stopper guide is opened to form an accommodation recess. The folding door apparatus also includes a stopper having a protrusion corresponding to the accommodation recess of the stopper guide and shock-absorbing parts on both sides of the protrusion. The width of the shock-absorbing parts is variable in the transverse direction of the stopper.

According to various aspects of the present invention, the stopper guide may include a plate-shaped base having a preset thickness which extends in the lateral direction of the vehicle and wings which are bent from both ends of the base toward the front side of the vehicle and extend a preset length. The stopper guide may be “C” shaped. Each of the wings of the stopper guide may have an engaging recess which has a slope on the inner side thereof, the angle of the slope being increased gradually toward the inside of the stopper guide.

A first shock-absorbing member may be fitted into the engaging recess of each of the wings of the stopper guide, the shape of the first shock-absorbing member corresponding to the shape of the engaging recess. The first shock-absorbing member may include a plate-shaped corresponding portion having a predetermined thickness and an engaging protrusion coupled to a lower portion of the corresponding portion, the length of the corresponding portion is substantially equal to the length of each of the wings.

Each of the wings of the stopper guide may have an engaging rib at a point where each of the wings is coupled with the front end of the corresponding portion of the first shock-absorbing member to prevent the first shock-absorbing member from being dislodged. The base of the stopper guide may have engaging bars on the inner surface thereof, at points that are spaced apart a preset distance from each other, the engaging bars being elongated in a top-down direction.

Each of the shock-absorbing parts of the stopper may include an elastic member which is coupled to the protrusion in the direction substantially perpendicular to the transverse direction of the stopper and a plate-shaped second shock-absorbing member having a preset thickness which is coupled to the outer end of the elastic member.

The protrusion and the second shock-absorbing member of the stopper may have engaging recesses at positions corresponding to the elastic member to prevent the elastic member from being dislodged. The rear end of the second shock-absorbing member of the stopper may be bent toward the protrusion.

Therefore, the folding door apparatus for a vehicle having the above-described structure removes noise that is created between the stopper and the stopper guide due to the vibration of the vehicle body and the movement of the door. In addition, even if the position of the door is changed to deviate from the range of tolerance, the width of the shock-absorbing parts of the stopper is varied so that the protrusion of the stopper can be seated in the accommodation recess of the stopper guide. In particular, since the stopper can slide by being guided by the slopes of the stopper and stopper guide, the stopper can be accurately coupled with the stopper guide.

In addition, the elastic members are provided between the protrusion and the second shock-absorbing members of the stopper in order to prevent noise from being created between the protrusion and the second shock-absorbing members. The slopes of the engaging recesses, the engaging ribs and the engaging bars are provided in order to prevent the first shock-absorbing members which are additionally fitted into the stopper guide from being dislodged from the stopper guide due to impact, vibration or the like that is created during driving of the vehicle or operation of the door.

It is possible to ensure that a large gap be formed between the wings of the stopper guide and the second shock-absorbing members of the stopper so that the stopper does not collide against the stopper guide, thereby removing noise and improving the endurance of parts.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing the state in which an exemplary folding door apparatus for a vehicle according to the present invention is coupled to a vehicle;

FIG. 2 is an enlarged view of part A shown in FIG. 1;

FIG. 3 is an enlarged view of an exemplary stopper guide;

FIG. 4 is an enlarged view of an exemplary stopper;

FIG. 5 is an enlarged view of an exemplary second shock-absorbing member of the shock-absorbing part;

FIG. 6 is an enlarged view of an exemplary elastic member of the elastic part;

FIG. 7 is an enlarged view of part B shown in FIG. 2; and

FIG. 8 is a view showing the state in which an exemplary stopper is inserted into the accommodating recess of an exemplary stopper guide beyond the range of tolerance.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Wherever possible, the same reference numerals will be used throughout the drawings and the description to refer to the same or like parts.

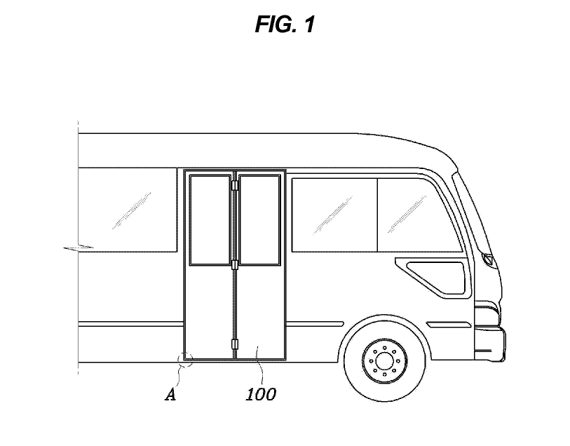

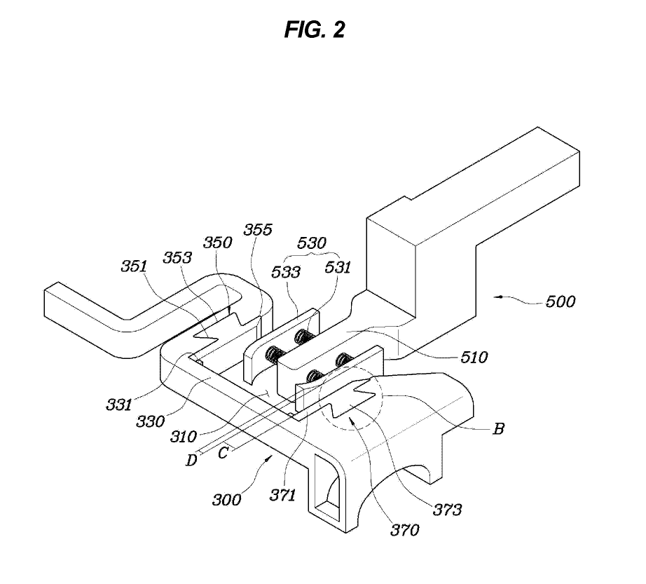

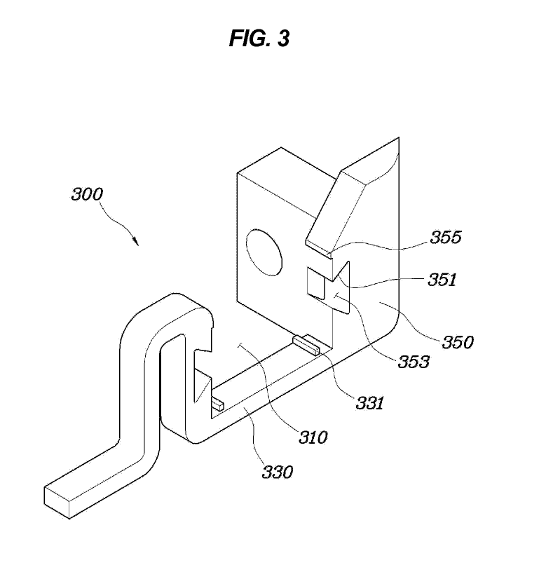

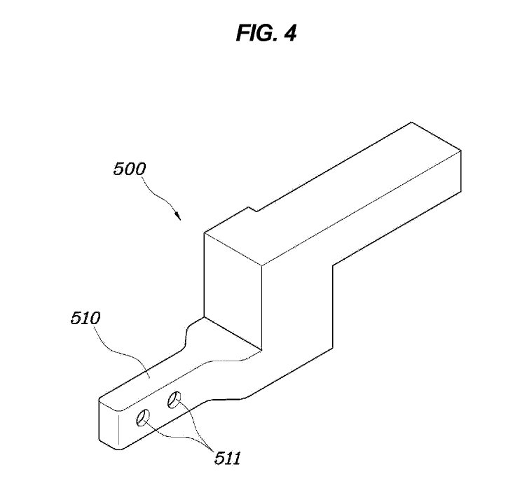

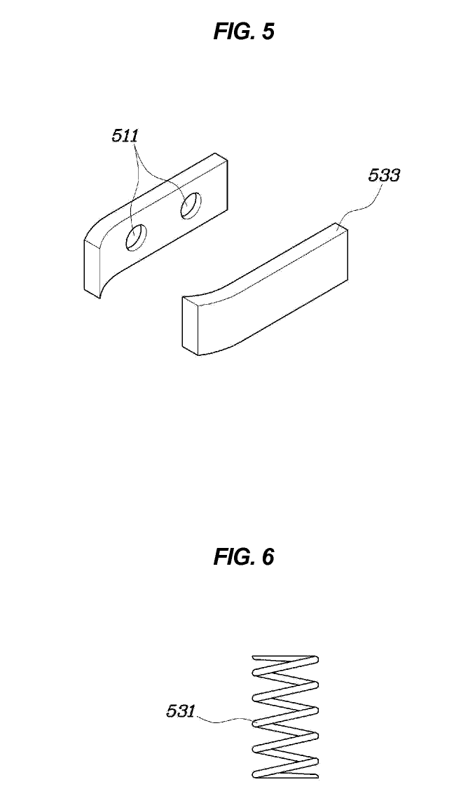

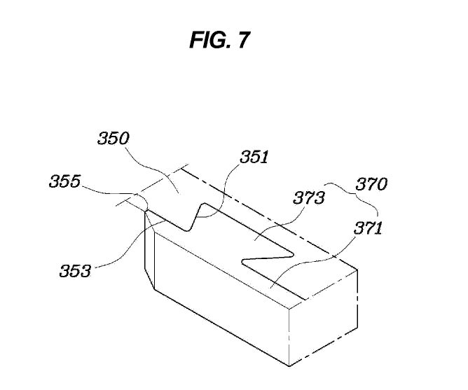

FIG. 1 is a view showing the state in which a folding door apparatus for a vehicle according to various embodiments of the present invention is coupled to a vehicle, FIG. 2 is an enlarged view of part A shown in FIG. 1, FIG. 3 is an enlarged view of a stopper guide 300, FIG. 4 is an enlarged view of a stopper 500, FIG. 5 is an enlarged view of a second shock-absorbing member 533 of a shock-absorbing part 530, FIG. 6 is an enlarged view of an elastic member 531 of an elastic part 530, and FIG. 7 is an enlarged view of part B shown in FIG. 2.

The folding door apparatus for a vehicle according to various embodiments of the present invention includes a stopper guide 300 and a stopper 500. The stopper guide 300 is provided on a point of a vehicle body that adjoins the lower end of a vehicle door, and is opened at one side to form an accommodation recess 310. The stopper 500 has a protrusion 510 which protrudes to correspond to the accommodation recess 310 of the stopper guide 310 and shock-absorbing parts 530 on both sides of the protrusion 510. The width of the shock-absorbing parts 530 is variable in the transverse direction of the protrusion 510.

The folding door apparatus for a vehicle according to various embodiments, and as shown in FIG. 1, is used for a foldable middle door which is mounted on a minibus or the like. The folding door apparatus of the present invention can also be applied to any structure such as a large bus on which a foldable door is mounted. The folding door is folded or unfolded as a roller guide provided on the upper end of the door follows along a track of a position corresponding to a roller guide provided in the vehicle body following the operation of a cylinder arm which is connected to an electric door cylinder. Therefore, since the door is momentarily folded or unfolded due to power from the electric door cylinder, impact, noise and vibration are created at a portion where the door adjoins the vehicle body. In order to prevent this, the stopper 500 is provided on the lower end of the door, and the stopper guide 300 is provided at a position of the vehicle body that corresponds to the stopper 500.

As shown in FIG. 2 and FIG. 3, in the stopper guide 300, the accommodation recess 310 is defined by a plate-shaped base 330 and wings 350. The base 330 has a preset thickness, and extends in the lateral direction of the vehicle. The wings 350 are bent toward the front side of the vehicle from both ends of the base 330, and extend a preset length. The stopper guide 300 is provided below a point where the side surface of the vehicle door corresponds to the vehicle body. The protrusion 510 of the stopper 500 retracts into or protrudes from the accommodation recess 310. The base 330 and the wings 350 are in the shape of a “C”.

Each of the wings of the stopper guide 300 has an engaging recess 353 in the inner surface thereof. The engaging recess 353 has inclined portions 351, the angle of which increases gradually inward of the stopper guide 300. Since the angle of the inclined portions 351 of the engaging recess 353 gradually increases, when a first shock-absorbing member 370, the shape of which corresponds to that of the engaging recess 353, is fitted into the engaging recess 353, it is possible to prevent the first shock-absorbing member 370 from being dislodged toward the accommodation recess 310 of the stopper guide 300 without any device designed for that purpose.

The first shock absorbing member 370 includes a plate-shaped corresponding portion 371 which has a preset thickness and an engaging protrusion 373 which engages with the lower portion of the corresponding portion 371. Since the engaging protrusion 373 having the shape corresponding to that of the engaging recess 353 of the wing 350 is fitted into and engaged with the engaging recess 353, the first shock-absorbing member 370 is prevented from being dislodged from the stopper guide 300 by impact and vibration that occur in the vehicle.

In particular, the corresponding portion 371 of the first shock-absorbing member 370 extends a length corresponding to the length of the wing 350 and provides shock absorption to the wing 350 which would otherwise be directly subjected to impact from the protrusion 510 of the stopper 500. In this fashion, the shock-absorbing member 370 increases the endurance of parts and removes noise and vibration created by the operation of the door.

In addition, as shown in FIG. 7, each of the wings 350 of the stopper guide 300 has an engaging rib 355 on a portion that engages with the front end of the corresponding portion 371 of the first shock-absorbing member 370. The engaging ribs 355 of the wings 350 serve as a secondary device that prevents the first shock-absorbing member 370 from being dislodged by impact, vibration or the liked applied thereto.

Furthermore, the base 330 of the stopper guide 300 has engaging bars 331 on the inner surface, at points that are spaced apart a preset distance from each other, i.e. a distance corresponding to the thickness of the corresponding portion 371 of the first shock-absorbing member 370. The engaging bars 331 are elongated in the top-down direction. This configuration prevents the first shock-absorbing member 370 from being dislodged from the stopper guide 300 once again.

FIG. 4 is an enlarged view of the stopper 500, in which the protrusion 510 is provided. FIG. 5 and FIG. 6 are enlarged views of respective components of the shock-absorbing parts 530 of the stopper 500.

Each of the shock-absorbing parts 530 of the stopper 500 includes the elastic members 531 which are coupled with the protrusion 510 in the transverse direction and the second shock-absorbing member 533 which is coupled with the outer ends of the elastic members 531. The second shock-absorbing member 533 has the shape of a plate having a preset thickness.

The protrusion 510 and the second shock-absorbing members 533 of the stopper 500 have coupling recesses 511 at positions corresponding to the elastic members 531 such that the elastic members 531 can be more firmly coupled without being dislodged. The elastic members 531 are mainly implemented as coil springs, of which the upper and lower end surfaces are formed through compression such that they can adjoin the surfaces of the protrusion 510 and the second shock-absorbing members 533 so that the elastic members 531 can more reliably operate.

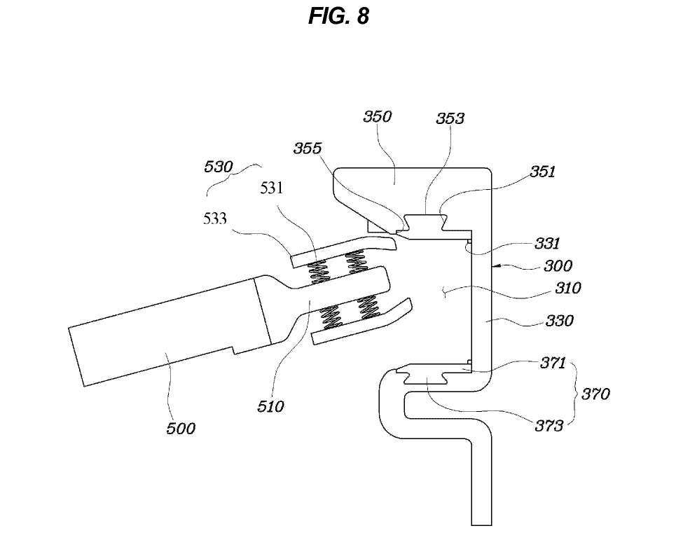

As shown in FIG. 8, referring to the shape of the second shock-absorbing members 533 of the stopper 500, each rear end portion thereof is bent toward the protrusion 510, thereby forming a slope that is inclined at a preset angle. Each of the wings 350 of the stopper guide 300 has a slope at a corner that is inclined outward at a preset angle such that the each wing becomes gradually wider. When the stopper 500 is inserted into the stopper guide 300 in which the state of the door is beyond an allowable tolerance, the slopes adjoin each other while the stopper 500 is sliding, so that the stopper 500 is reliably accommodated in the accommodation recess 310 of the stopper guide 300.

This can be appreciated from ranges of tolerance indicated by “C” and “D” in FIG. 2. Since “C” is formed wider than “D,” the stopper 500 is normally seated in the accommodation recess 310 of the stopper guide even if the relatively-small width of the slope of the second shock-absorbing member 533 deviates from the allowable tolerance.

At a deviation from the allowable tolerance, even if the gap between the stopper guide 300 and the stopper 500 is small, the shock-absorbing parts 530 of the stopper 500 are elastically pressed so that the width thereof is reduced. Consequently, the stopper 500 is reliably and safely mounted without noise.

Therefore, the folding door apparatus for a vehicle according to various embodiments of the present invention removes noise that is created between the stopper and the stopper guide due to the vibration of the vehicle body and the movement of the door. In addition, even if the position of the door is changed to deviate from the range of tolerance, the width of the shock-absorbing parts of the stopper is varied so that the protrusion of the stopper can be seated in the accommodation recess of the stopper guide. In particular, since the stopper can slide by being guided by the slopes of the stopper and stopper guide, the stopper can be accurately coupled with the stopper guide.

In addition, the elastic members are provided between the protrusion and the second shock-absorbing members of the stopper in order to prevent noise from being created between the protrusion and the second shock-absorbing members. The slopes of the engaging recesses, the engaging ribs and the engaging bars are provided in order to prevent the first shock-absorbing members which are additionally fitted into the stopper guide from being dislodged from the stopper guide due to impact, vibration or the like that is created during driving of the vehicle or operation of the door.

It is possible to ensure that a large gap be formed between the wings of the stopper guide and the second shock-absorbing members of the stopper so that the stopper does not collide against the stopper guide, thereby removing noise and improving the endurance of parts.

For convenience in explanation and accurate definition in the appended claims, the terms “upper” or “lower”, “inner” or “outer”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A folding door apparatus for a vehicle comprising:
a stopper guide disposed at a body side of a vehicle, wherein the stopper guide is positioned at a point where a lower end of a door of the vehicle adjoins, and one side of the stopper guide is opened to form an accommodation recess; and
a stopper having a protrusion corresponding to the accommodation recess of the stopper guide and shock-absorbing parts on both sides of the protrusion, wherein a width of the shock-absorbing parts is variable in a transverse direction of the stopper.

2. The folding door apparatus according to claim 1, wherein the stopper guide comprises a plate-shaped base having a preset thickness which extends in a lateral direction of the vehicle and wings which are bent from both ends of the base toward a front side of the vehicle and extend a preset length.

3. The folding door apparatus according to claim 2, wherein the stopper guide is “C” shaped.

4. The folding door apparatus according to claim 2, wherein each of the wings of the stopper guide has an engaging recess which has a slope on an inner side thereof, an angle of the slope being increased gradually toward an inside of the stopper guide.

5. The folding door apparatus according to claim 4, wherein a first shock-absorbing member is fitted into the engaging recess of each of the wings of the stopper guide, a shape of the first shock-absorbing member corresponding to a shape of the engaging recess.

6. The folding door apparatus according to claim 5, wherein the first shock-absorbing member comprises a plate-shaped corresponding portion having a predetermined thickness and an engaging protrusion coupled to a lower portion of the corresponding portion, a length of the corresponding portion is substantially equal to the length of each of the wings.

7. The folding door apparatus according to claim 6, wherein each of the wings of the stopper guide has an engaging rib at a point where each of the wings is coupled with a front end of the corresponding portion of the first shock-absorbing member to prevent the first shock-absorbing member from being dislodged.

8. The folding door apparatus according to claim 2, wherein the base of the stopper guide has engaging bars on an inner surface thereof, at points that are spaced apart a preset distance from each other, the engaging bars being elongated in a top-down direction.

9. The folding door apparatus according to claim 1, wherein each of the shock-absorbing parts of the stopper comprises an elastic member which is coupled to the protrusion in a direction substantially perpendicular to the transverse direction of the stopper and a plate-shaped second shock-absorbing member having a preset thickness which is coupled to an outer end of the elastic member.

10. The folding door apparatus according to claim 9, wherein the protrusion and the second shock-absorbing member of the stopper have engaging recesses at positions corresponding to the elastic member to prevent the elastic member from being dislodged.

11. The folding door apparatus according to claim 9, wherein a rear end of the second shock-absorbing member of the stopper is bent toward the protrusion.
